(19) United States
(12) Patent Application Publication
(10) Pub. No.: US 2026/0364720 A1
(43) Pub. Date: Nov. 19, 2026

(54) WORKPIECE PART COMPRISING PARTS OF ELONGATED DAMAGE REGIONS

(71) Applicant: UAB ALTECHNA R&D, VILNIUS (LT)

(72) Inventor: Mindaugas Mikutis, VILNIUS (LT)

(21) Appl. No.: 19/750,329

(22) Filed: Jul. 22, 2026

Related U.S. Application Data
(63) Continuation of application No. 15/761,596, filed on Sep. 30, 2016, now Pat. No. 12,691,531.

(30) Foreign Application Priority Data
Oct. 2, 2015 (LT) 2015085

(51) Int. Cl. B23K 26/53; B23K 26/00; B23K 26/062; B23K 26/064; B23K 26/073; B23K 26/08; C03B 33/02

(52) U.S. Cl. CPC B23K 26/53; B23K 26/0006; B23K 26/0626; B23K 26/064; B23K 26/0648; B23K 26/0652; B23K 26/0736; B23K 26/0823; C03B 33/0222; Y02P 40/57

(57) ABSTRACT

Disclosed is a workpiece part comprising parts of elongated damage regions which are arranged longitudinally one after another along a predefined trajectory and form a cutting and/or breaking plane along which a workpiece was divided to form the workpiece part wherein the material of the workpiece part is transparent. Each elongated damage region part in the workpiece material extends over a length in a first direction and has a shape that is elongated in a plane perpendicular to the first direction.

### CROSS REFERENCE TO RELATED APPLICATIONS

This application is a Continuation of national phase Application Ser. No. 15/761,596, filed on Mar. 20, 2018 which claims the benefit of priority under 35 U.S.C. § 371 of International Application No. PCT/EP 2016/073460, filed on Sep. 30, 2016, which claims the benefit of priority to Lithuanian Application No. 2015085 filed on Oct. 2, 2015, the content of all of which is incorporated herein by reference in its entirety.

### TECHNICAL FIELD TO WHICH INVENTION RELATES

Invention relates to the laser field and namely to processing of transparent materials and can be used for cutting, breaking and other processing procedures of transparent materials, including glass, chemically tempered glass, sapphire and other crystalline materials, by the use of ultrashort pulse asymmetric Gauss-Bessel intensity distribution laser beam.

### BACKGROUND ART

Most of the methods and devices for cutting, scribing or breaking transparent materials are based on focusing of the laser beam generated by the laser source on the surface or in the bulk of the transparent materials, forming a crack in the transparent material, which causes the transparent material to separate or break due to effect of external force.

An international patent application WO2012006736 discloses a method for pre-cutting of a transparent material, which comprises the steps of: directing ultrashort pulse laser beam to a workpiece and focusing within it, wherein the material of the workpiece is transparent to the focused laser beam. The laser pulse duration and energy are selected to form a thread-like damage region (filament) that extends through the workpiece along the beam propagation direction. The workpiece is selectively translated relative to the focused laser beam to define a trajectory for cutting the workpiece or separating a part from the workpiece.

A similar method and apparatus for processing of transparent materials is described in an international patent application WO 2014/079478 A1. A method for processing transparent materials that employs ultrashort pulse Gaussian intensity distribution laser beam is described. The method comprises the following sequence of operations: directing an ultrashort pulse Gaussian intensity distribution laser beam to an optical system, forming Gauss-Bessel intensity distribution laser beam, which is directed and localized in the workpiece by optical elements. The material of the workpiece is transparent to the localized Gauss-Bessel intensity distribution laser beam, and the laser pulse duration and energy are selected to exceed the optical damage threshold of the workpiece material and to form a damage region, consisting of micro cracks, which extends across the workpiece along the propagation direction of the focused laser beam. Displacement of the workpiece relative to the focused laser beam permits formation of additional damage regions, forming a trajectory of a cutting/breaking plane.

Devices for processing transparent materials that employ a single pulse of Gaussian or Gauss-Bessel laser beam to penetrate a partial or full thickness of the workpiece are known. Known methods and devices localize a Gauss-Bessel intensity distribution laser beam in a transparent workpiece to form a damage region that extends in the direction of propagation of the laser beam. The damage region has a circular shape in a plane perpendicular to the direction of laser beam propagation. A succession of damage regions having a circular shape define a trajectory of a cut and/or break plane. Such a cut and/or break plane formed in the workpiece, consisting of damage regions that have a shape close to a circle, creates stress and cracks of random direction or even several directions in the bulk and on the surface of the workpiece in respect to the trajectory of cut and/or break plane. This negatively influences the cut and/or break quality, especially when the cut and/or break plane trajectory is comprised of various radius curves. Formation of random cracks and stresses in the bulk and surface of the workpiece in directions away from the intended cut trajectory also reduces the mechanical strength of the processed workpiece, which leads to defective parts, greater consumption of the workpiece material, and less efficient processes.

### DISCLOSURE OF THE INVENTION

According to a first aspect of the invention there is provided a method of processing transparent materials according to claim 1.

In another aspect, there is provided a method of processing transparent materials according to claim 19.

The elongated shape of the induced damage region in the plane perpendicular to the laser beam propagation direction may be similar to the shape of an ellipse.

The elongated shape damage regions may be positioned at a certain distance one from another within the workpiece along the trajectory of the cutting and/or breaking plane, so that the distance dx between the centers of the adjacent damage regions is in the range from about 0.5 to about 15 lengths of a single damage region (18b), where the length of a damage region along the longer axis (18e) is from about 1 μm to about 20 μm, and the length of the damage region along the longer axis is from 1.3 to 5 times, preferably 2 times, larger than the length along the shorter axis. The transparent material of the workpiece is selected from the group consisting of glass, chemically strengthened glass, sapphire or other crystalline material.

The length of the damage region induced in the transparent workpiece along the laser beam propagation direction may be shorter than the thickness of the plate-like workpiece and not be adjoined to any of the surfaces of the plate-like workpiece, or the length of the damage region may coincide with the thickness of the workpiece and be adjoined to both of the surfaces of the plate-like workpiece, or the length of the damage region may be shorter than the thickness of the plate-like workpiece and adjoined to only one of the surfaces.

The transparent material of the workpiece may be glass (including for example thermally strengthened glass), chemically strengthened glass, sapphire or other crystalline material.

According to a further aspect of the invention there is provided a device for processing transparent materials according to claim 7.

In a yet further aspect, there is provided a device for processing transparent materials according to claim 24.

The optical element may be a transparent plate, that is placed in the optical path of the Gaussian or Gauss-Bessel intensity profile laser beam in such a manner, that it covers half of the laser beam, where the covered and uncovered parts of the laser beam are symmetrical, and the uncovered part of the beam passes directly, whereas the covered part of the beam passes through the transparent plate.

The optical element may be a transparent plate having a first zone and a second zone of different thickness, which is placed in the optical path of the Gaussian or Gauss-Bessel intensity profile laser beam in such a manner, that the laser beam is split in to two parts, where the first part of the beam passes through the first zone of the plate and the second part of the beam passes through the second zone of the plate. The two parts may be equal symmetric parts.

The optical element may be a transparent plate having a first zone and a second zone of different refractive index, which is placed in the optical path of the Gaussian or Gauss-Bessel intensity profile laser beam in such a manner, that the aforementioned beam is split in to two parts, where the first part of the beam passes through the first zone of the plate and the second part of the beam passes through the second zone of the plate. The two parts may be equal symmetric parts.

The controlled positioning mechanism may comprise a rotary stage, to which the optical is attached, and a linearly movable stage, to which the workpiece is attached, wherein the stages may be controlled by the controller, which receives commands from a computer according to a predefined trajectory of the cutting and/or breaking plane in such a manner, that the direction of trajectory of the cut and/or break plane is controlled by the stage, rotating the optical element, and the positioning of the damage regions in the workpiece at a certain displacement distance is controlled by stage linearly moving the workpiece.

The positioning mechanism may comprise a Dove prism, placed in the optical path of the Gaussian or Gauss-Bessel intensity profile laser beam behind the stationary optical element and attached to the rotary stage, and the linear motion stage, to which the workpiece is attached, wherein rotary and linear motion stages are controlled by controller, which receives commands from computer according to predefined trajectory of the cutting and/or breaking plane in such a manner, that the direction of trajectory of the cut and/or break plane is controlled by stage rotating Dove prism, and the positioning of the damage regions in the workpiece at a certain displacement distance is controlled by stage linearly moving the workpiece.

A quarter wave phase plate for changing polarization state of the laser radiation of the laser source from linear to circular, may be placed in the laser beam path in front of or behind the optical element and in front of the Dove prism along the direction of the laser beam propagation.

A half wave phase plate for maintaining the same polarization state of the laser radiation of the laser source may be placed in the laser beam path behind the optical element and in front of the Dove prism according to the direction of the laser beam propagation and attached to the stage for rotating phase plate together with the Dove prism.

The proposed method and a device for processing of transparent materials results in the formation of damage regions in a workpiece that have an elongated (asymmetric) shape in the direction of laser beam propagation and in the plane perpendicular to the direction of laser beam propagation. The direction and distance between damage regions formed in the workpiece by the laser is controlled by a positioning mechanism that positions the elongated (asymmetric) damage regions in succession at the controlled locations along the trajectory of the cut and/or break plane needed to form a required cut and/or break in the workpiece. The elongated damage regions induced in the workpiece preferably have a shape similar to an ellipse. Such elongated damage regions will result in a crack propagating within the damage region along the lengthwise dimension of the damage region. According to the proposed method and device, formation of the breaking and/or cutting plane with elongated damage regions affords control of the direction of stress or crack formation in the workpiece to preferentially form stress or cracks along the cut trajectory to minimize or avoid cracks and stress in random directions in the bulk or surface of workpiece away from the cut trajectory.

In some embodiments, this may result in significantly improved processing quality of the transparent materials, improved workpiece material yield, processing throughput and processing speed of free form plate-like transparent material workpieces. Processing quality, throughput and processing speed may improve due to elongation of the damage region and due to an orderly arrangement of micro cracks along the trajectory of the cut and/or break plane, due to orderly guidance of the micro cracks and the size of them.

### BRIEF DESCRIPTION OF THE DRAWINGS

FIG. 1 is a principal block scheme of the proposed device for processing of transparent materials.

FIG. 2 is configuration and displacement of an optical element with respect to laser beam for disrupting symmetry of the intensity profile of the laser beam.

FIG. 3a is a principal optical layout of the proposed device, according to an embodiment where the optical element is attached to a rotary stage and located in the Gaussian intensity profile laser beam path behind the optics, forming the Gauss-Bessel intensity profile laser beam.

FIG. 3b is a principal optical layout of the proposed device, according to an embodiment where the optical element is attached to a rotary stage and located in the Gauss-Bessel intensity profile laser beam path (two alternative optical layouts are shown).

FIG. 4a is a principal optical layout of the proposed device, according to an embodiment where the stationary optical element is located in the optical path of the Gaussian intensity profile laser beam and behind it a Dove prism attached to a rotary stage is located.

FIG. 4b is a principal optical layout of the proposed device, according to an embodiment where the stationary optical element is located in the optical path of the Gaussian intensity profile laser beam, and a Dove prism, attached to a rotary stage, is located in the optical path of the Gauss-Bessel intensity profile laser beam.

FIG. 5 is a collection of photos of damage regions: (top row) induced in the transparent material workpiece by symmetric and asymmetric Gauss-Bessel intensity profile laser beam (bottom row), where

18a—is a damage region surrounded by random direction cracks induced in the bulk of the transparent material workpiece by symmetric Gauss-Bessel intensity profile laser beam (there is no optical element in the optical path, which would transform the laser beam to asymmetric Gauss-Bessel intensity profile laser beam).

18b—is a damage region with cracks induced in the bulk of the transparent material workpiece by asymmetric Gauss-Bessel intensity profile laser beam (there is an optical element in the optical path of the laser beam, which transforms it to asymmetric Gauss-Bessel intensity profile laser beam).

FIG. 6 is a schematic drawing illustrating laser induced modifications of elongated shape, similar to the shape of an ellipse, displaced one after another longitudinally along cut and/or break plane trajectory.

FIG. 7 is a collection of four alternative embodiments of length 18f and allocation of damage regions induced in the bulk of transparent material workpiece.

FIG. 8 is a photograph of damage regions induced in the bulk of transparent material workpiece, illustrating control over crack direction by a rotation of optical element.

### DETAILED DESCRIPTION OF THE INVENTION

Referring to the figures, a device for laser processing of transparent materials, comprises:
a laser source 1, generating ultrashort pulse Gaussian intensity profile laser beam 2,
an optical element (3, 3′, 3″), transforming Gauss-Bessel intensity profile ultrashort pulse laser beam to asymmetric Gauss-Bessel intensity profile laser beam,
a controlled rotation device (4a, 4b), directing damage region 18b along the desired direction within the workpiece 7, while forming cutting and/or breaking plane trajectory,
an optical system 5, forming Gauss-Bessel intensity profile laser beam and localizing it within the workpiece 7 which is transparent to the localized laser beam,
a stage 8, which is capable of linear motion, controlled by controller 10, which receives control commands from computer 9,
an optical element 11 generating Gauss-Bessel intensity profile laser beam, such as spatial light modulator, conical lens (axicon),
a setup of optical components 12, 13, localizing Gauss-Bessel intensity profile laser beam in the bulk of the workpiece 7,
a transparent plate 14a, for performing the function of the optical element (3, 3′, 3″),
a transparent plate 14b that comprises two zones of different thickness, for performing the function of the optical element (3, 3′, 3″),
a transparent plate 14c that comprises two zones of different refractive index, for performing the function of the optical element (3, 3′, 3″),
a stage (15, 15′, 15″) capable of rotation motion, for rotation of optical element (3, 3′, 3″) or Dove prism (16, 16′).

An optical setup 19 for formation of asymmetric Gauss-Bessel intensity profile laser beam includes the optical element (3,3′,3″), controlled rotation device (4a,4b) and the optical system (5).

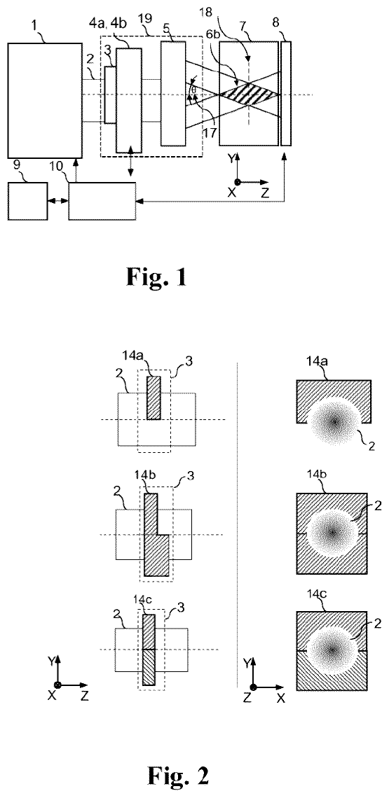

FIG. 1 is a principal block schematic of a proposed device for processing of transparent materials. The material of the plate-shaped workpiece is transparent to laser radiation 2 of the laser source 1.

In some embodiments, suitable laser wavelengths for forming damage regions are wavelengths at which the combined losses due to absorption and scattering by the workpiece at the wavelength are less than 20%/mm, or less than 15%/mm, or less than 10%/mm, or less than 5%/mm, or less than 1%/mm, where the dimension “/mm” means per millimeter of distance within the workpiece in the direction of propagation of the laser beam. When the workpiece is transparent to the laser wavelength, transfer of energy from the laser to the workpiece may occur primarily through non-linear processes that are enabled by the high intensity of the ultrashort pulse radiation. Non-linear processes include multi-photon processes such as two-photon absorption.

The method is realized by selecting the optical setup 19 for formation of an asymmetric Gauss-Bessel intensity profile laser beam and by selecting parameters of laser radiation so that the interaction of pulsed asymmetric Gauss-Bessel intensity profile laser beam 6b with the material of the workpiece 7 induces a damage region 18b in the workpiece material, which has a shape that is elongated (asymmetric) in laser beam propagation direction and in the plane perpendicular to the direction of laser beam propagation. The number and positioning of the induced damage regions 18b longitudinally forming a succession of damage regions 18c is controlled by the controller 10 commanded by the computer 9 to displace the workpiece 7 and the asymmetric Gauss-Bessel intensity profile laser beam, with with respect to each other. The induced elongated damage regions 18b interconnect along the trajectory via micro-cracking planes that are induced due to the buildup of inner stress in the surroundings of the damage region to a breaking plane 18d. The size and magnitude of damage regions 18b within the workpiece material is controlled via the selection of pulsed laser beam characteristics, such as laser pulse duration, average laser pulse energy, laser wavelength and Gauss-Bessel intensity profile laser beam cone angle. Typical length of a damage region 18b along the longer axis 18e, in the plane perpendicular to laser beam propagation direction, is from about 1 μm to about 20 μm, and the length of the damage region along the longer axis is from 1.3 to 5 times, preferably 2 times, larger than the length along the shorter axis, depending on the workpiece material type, thickness and layered structure if one has such.

The method is realized by an ultrashort pulse laser, which has a pulse duration in the range of about 1 ps to 100 ps, such as in the range from 10 ps to 100 ps. An average laser pulse energy measured at the workpiece material, is set to be less than about 1000 μJ, such as less than about 400 μJ. The wavelength of the laser source is selected so that the energy of a single photon of that laser wavelength is less than the band gap of the workpiece material, and less than about 3 μm. The optical setup 19 is such that half of the cone angle 17 of the Gauss-Bessel intensity profile laser beam is in the range from 4 to 45 degrees, for example in the range from 4 to 20 degrees. By translating the plate-shaped workpiece 7 and asymmetric Gauss-Bessel intensity profile laser beam 6b, having an elongated shape similar to an ellipse in the plane perpendicular to the beam propagation direction, relative to each other, subsequent modifications are displaced longitudinally along the cutting and/or breaking plane trajectory by a certain distance dx, which can be in the range from 0.5 to 15 multiplied by the length of the single damage region along the longer axis 18e, depending on type of the workpiece material, thickness and layered structure if applicable.

The characteristics of the optical setup 5 and the laser beam 2 are selected such that the interaction of an asymmetric Gauss-Bessel intensity profile laser beam 6b, having an elongated shape similar to an ellipse in the plane perpendicular to the beam propagation direction, and the workpiece 7 material induces a damage region 18b along the laser beam propagation direction, where the length 18f of the damage region 18b is shorter than the thickness of the plate-shaped workpiece 7 and is not adjoined to any of the surfaces of the plate-shaped workpiece, or the length 18f of the damage region coincides with the thickness of the plate-shaped workpiece and is adjoined to both of the surfaces 7a, 7b of the plate-shaped workpiece, or the length 18f of the damage region is shorter than the thickness of the plate-shaped workpiece 7 and is adjoined to its front surface 7a, or the length 18f of the damage region is shorter than the thickness of the plate-shaped workpiece 7 and is adjoined to its back surface 7b.

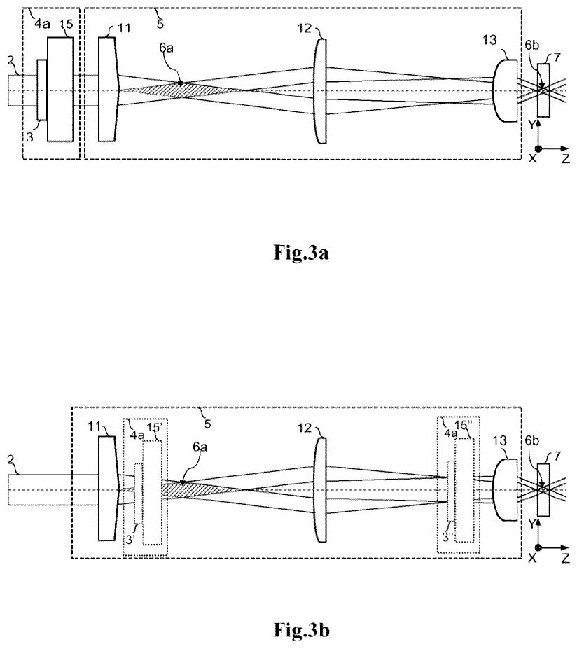

FIG. 3a is a principal optical layout of an embodiment of the method disclosed, where an ultrashort pulse laser 1 generated Gaussian intensity profile laser beam 2 is passed through an optical element 3 to disrupt the laser beam symmetry. The laser beam is further passed through a typical Bessel-Gauss beam generating optical element 11, such as spatial light modulator or conical lens, to transform the laser beam to asymmetric Gauss-Bessel intensity profile laser beam, which has an elongated shape, similar to that of an ellipse, in the plane perpendicular to the direction of the laser beam propagation. The asymmetric Gauss-Bessel intensity profile laser beam profile can be altered by a laser beam imaging optical setup 12, 13 or just localized in the bulk of the workpiece 7. The interaction of asymmetric Gauss-Bessel intensity profile laser beam and workpiece material results in damage region 18b, that leads to induction of micro-crack plane in the material 18d along the cutting and/or breaking plane trajectory, direction of which is controlled by rotation device 4a, where optical element 3 is rotated by a rotary stage 15. Successive laser pulses X_{N-1}, X_{N}, X_{N+1} 18c at a certain pulse to pulse distance are positioned within the material by the use of translation stages 8 and a rotary stage 15 and a controller 10, all of which get commands from a computer 9 according to a predetermined cutting and/or breaking plane trajectory. Alternatively, optical setup with or without the laser source 1 can be translated in respect to the workpiece to get the same effect.

FIG. 3b is a principal optical layout of another embodiment of the method disclosed, that is based on the first embodiment. A controlled rotation device 4a, comprising optical element (3′, 3″) attached to a rotary stage (15′, 15″), is used to set the direction of the crack of the damage region 6b in the workpiece 7 while inducing the cutting and/or breaking plane trajectory. The controlled rotation device 4a, is located in the optical path of the Gauss-Bessel intensity profile laser beam behind the optical element 11 in the direction of the laser beam propagation, which generates Gauss-Bessel intensity profile laser beam or alternatively located between optical elements 12 and 13.

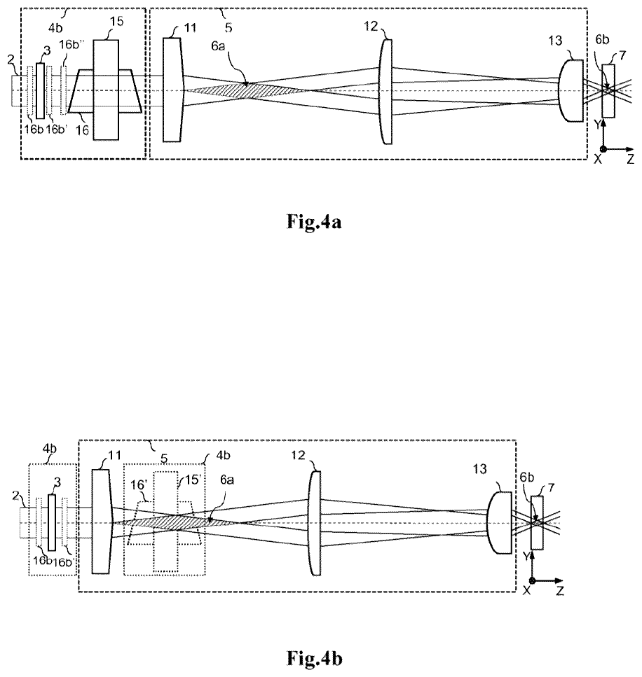

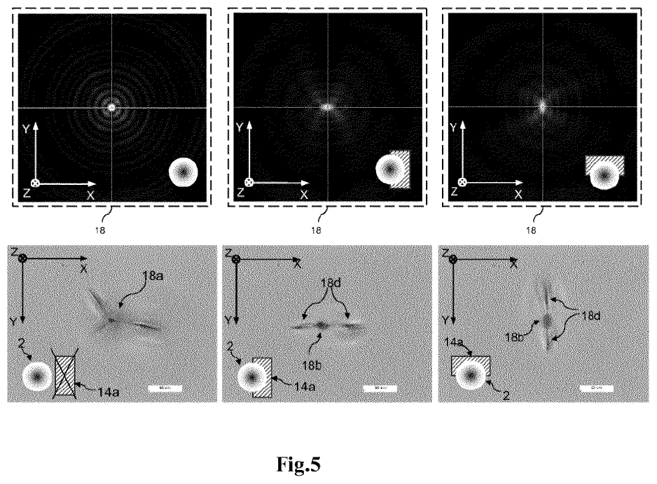

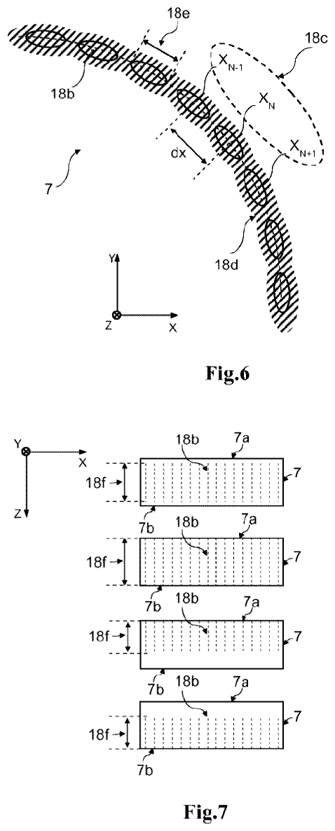

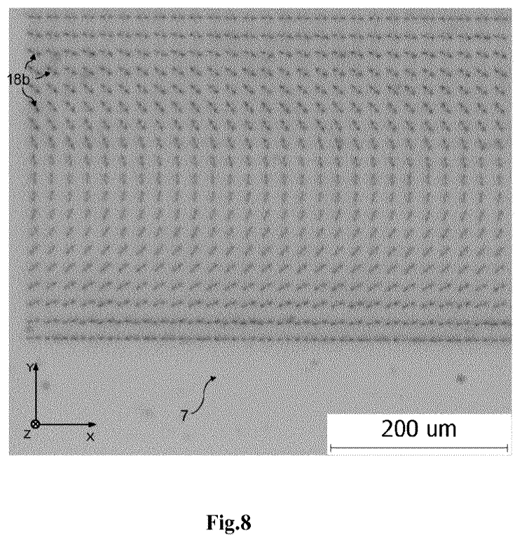

FIG. 4a is a principal optical layout of yet another embodiment of the method disclosed, where optical layout 19 comprises a controlled rotation device 4b, which is located in the optical path of the Gaussian intensity profile beam 2 in front of optical setup 5, which is used to generate Gauss-Bessel intensity profile laser beam. Controlled rotation device 4b comprises optical element 3 and a Dove prism 16, which is attached to a rotary stage 15 behind a stationary optical element 3 in the direction of the laser beam propagation. Ultrashort pulse laser 1 generated Gaussian intensity profile laser beam 2 is passed through a beam symmetry disrupting optical element 3, that is in the optical path of the Gaussian intensity profile laser beam 2, and then is passed through a typical Bessel-Gauss intensity profile laser beam generating optical element 11, such as spatial light modulator or conical lens. The resulting asymmetric Gauss-Bessel intensity profile laser beam can be altered by a laser beam imaging optical setup 12, 13 or just localized in the bulk of the workpiece 7. Interaction of the asymmetric Gauss-Bessel intensity profile laser beam and the workpiece material results in damage region 18b, that leads to induction of micro-crack plane trajectory in the material 18d, direction of which is controlled by rotating the image of the ultrashort pulse Gaussian intensity profile laser beam 2 passed through the optical element 3. This is realized by rotating the Dove prism 16 with the rotary stage 15. To overcome variations in reflection dependence on the Dove prism angle, if such arise, a quarter wavelength phase plate (16b, 16b′) can be used to change the linear polarization of the laser radiation into circular, or a half wavelength phase plate 16b″ can be rotated together with the Dove prism 16 to maintain the same laser beam polarization state. Successive laser pulses X_{N-1}, X_{N}, X_{N+1} 18c at a certain pulse to pulse distance are positioned within the material by the use of translation stages 8 and a rotary stage 15 and a controller 10, all of which get commands from a computer 9 according to a predetermined cutting and/or breaking plane trajectory. Alternatively, an optical setup with or without the laser source 1 can be translated with respect to the workpiece to get the same effect.

FIG. 4b is a principal optical layout of another embodiment of the method disclosed, that is based on the embodiment disclosed by the principal optical layout in FIG. 4a. In this embodiment the controlled rotation device 4b comprises stationary optical element 3, which is placed in the optical path of the Gaussian intensity profile laser beam 2, and behind it or in front of it a quarter wavelength phase plate (16b, 16b′) can be placed, intended for changing linear polarization state of the laser radiation to circular. A Dove prism 16′, is attached to a rotary stage 15′ for setting the direction of the crack of the damage region 6b in the workpiece 7 while inducing the cutting and/or breaking plane trajectory. Dove prism 16′ is located in the optical path of the Gauss-Bessel intensity profile laser beam behind the optical element 11 according to the direction of the laser beam propagation, which generates Gauss-Bessel intensity profile laser beam.

FIG. 2 shows some embodiments of optical element 3. Optical element 3 is a transparent material plate, material of which can be glass, crystal, or birefringent crystal, and/or having a layered structure influencing reflectivity, such as anti-reflecting coatings. The purpose of the optical element 3 in the embodiments of the proposed invention is to create asymmetry of the Gaussian or Gauss-Bessel intensity profile laser beam by introducing an additional optical path for a part of the laser beam. Due to an introduced asymmetry of the laser beam, the Gauss-Bessel intensity profile laser beam is transformed to an elongated, preferably having shape of an ellipse, Gauss-Bessel intensity profile laser beam 6b.

Optical element 3 can be realized using several technical solutions. Optical element 3 can be a glass plate 14a covering only a part of the laser beam. In an embodiment, the glass plate 14a is placed in the optical path of the Gaussian or Gauss-Bessel intensity profile laser beam in such a manner, that it covers half of the laser beam, where the covered and uncovered parts of the laser beam are symmetrical.

Due to aforementioned partial coverage of the laser beam by a glass plate 14a, an optical path difference is created between different parts of the laser beam and the symmetry of the intensity profile of the laser beam is disrupted. The thickness of the plate 14a is selected to transform Gauss-Bessel intensity profile laser beam to an asymmetric Gauss-Bessel intensity profile laser beam, such as 0.5 mm.

Another embodiment of optical element 3 is a transparent plate 14b, that comprises two zones of different thickness, and when placed in the optical path of the laser beam creates different optical path length to the parts of the laser beam that pass through the different zones. The two mentioned different thickness zones split the laser beam in to two equal symmetrical parts, where the first part of the beam passes through the first zone of the plate 14b and the second part of the beam passes through the second zone of the plate 14b.

Another embodiment of optical element 3 is a transparent plate 14c, that comprises two zones of different refractive index, and when placed in the optical path of the laser beam creates different optical path length to the parts of the laser beam that pass through the zones of different refractive index. Transparent plate 14c is placed in the optical path of the laser beam in such a manner, that the laser beam is split in to two equal symmetrical parts, where the first part of the beam passes through the first refractive index zone of the plate 14c and the second part of the beam passes through the second refractive index zone of the plate 14c.

According to other embodiments of the proposed invention the transparent plate (14a, 14b, 14c) can be placed in the optical path of the laser beam for partial coverage of the laser beam, splitting the beam to asymmetric parts and inducing damage regions of various shape, depending on the aforementioned asymmetry of the covered and uncovered laser beam parts.

According to embodiments of the proposed invention, the typical Gaussian intensity profile ultrashort pulse laser beam 2 may be transformed into an asymmetric Gauss-Bessel intensity profile laser beam, having an elongated shape in the plane perpendicular to laser beam propagation direction, and localized in the bulk of a transparent plate-shaped workpiece, where pulse energy is transferred to the workplace material via nonlinear processes and modification of the material takes place in a form of a damage region with micrometer size cracks. Due to a density change of the modified material in the damage region internal stress in the material forms a plane like micro-cracking, direction of which is controlled by rotation of the longer axis of the asymmetric/elongated Gauss-Bessel intensity profile laser beam. Inducing such modifications along a predefined trajectory creates a well-defined separation path, which is used to divide workpiece into parts of predefined shape by the mechanical force, thermal stress induced force or a timed self-break occurring due to inner stress present in the plate-shaped workpiece, depending on the plate-shaped workpiece type and layered structure.

Further, the present disclosure includes the following embodiments and combinations of embodiments:
1. Method for processing transparent materials comprising the steps of:
generating a Gauss-Bessel intensity profile laser beam in an optical system, localizing the generated Gauss-Bessel intensity profile laser beam in a workpiece (7), wherein the material of the workpiece is transparent to the Gauss-Bessel intensity profile laser beam, to form a damage region in the workpiece, the damage region extending in the direction of propagation of the laser beam,
performing controlled displacement of the workpiece (7) and the laser beam in respect to each other to create a required number of additional adjacent damage regions in a predefined trajectory in order to form a cutting and/or breaking plane of the workpiece (7),
characterised in that:
generating a Gauss-Bessel intensity profile laser beam comprises generating an asymmetric Gauss-Bessel intensity profile laser beam (6b) by placing an optical element (3, 3′, 3″) in the optical path of the beam, wherein asymmetry of the asymmetric Gauss-Bessel intensity profile laser beam is set by selecting appropriate material of the optical element (3, 3′, 3″) and/or parameters of the optical element (3, 3′, 3″) and/or position of the optical element (3, 3′, 3″) in the optical laser beam path in order to form elongated shape of the Gauss-Bessel intensity profile laser beam in the plane, perpendicular to the direction of propagation of the laser beam, inducing correspondingly an elongated damage region (18b) in the workpiece (7), and wherein the controlled displacement of the workpiece (7) and the laser beam relative to each other is performed in such a manner that the induced elongated shape damage regions (18b) are arranged in the workpiece (7) longitudinally one after other along the predefined trajectory of the cutting and/or breaking plane.
2. A method according to embodiment 1, further comprising directing an ultrashort pulse Gaussian intensity profile laser beam (2) from a laser source (1) to the optical system and generating the Gauss-Bessel intensity profile from the ultrashort pulse Gaussian intensity profile laser beam (2) in the optical system wherein a laser pulse duration and a laser pulse energy of the directed laser beam (2) are selected to exceed a material damage threshold of the workpiece (7) and to form in it a damage region, which extends in the direction of propagation of the laser beam.
3. A method according to embodiment 1 or 2, wherein the elongated shape of the induced damage region (18b) in the plane perpendicular to the laser beam propagation direction is in the shape of an ellipse.
4. Method according to embodiment 1, 2 or 3, wherein the elongated shape damage regions (18b) are positioned at a distance dx one from another within the workpiece (7) along the trajectory of the cutting and/or breaking plane, wherein the distance dx between the centers of the adjacent damage regions is in the range from 0.5 to 15 lengths of a single damage region (18e), where the length of a damage region (18b) along the longer axis (18e) is from 1 μm to 20 μm, and the length of the damage region along the longer axis is from 1.3 to 5 times, preferably 2 times, larger than the length along the shorter axis.
5. Method according to any of the embodiments 1-4, wherein the transparent material of the workpiece (7) is selected from the group consisting of glass, chemically strengthened glass, sapphire or other crystalline material.
6. Method according to any of the embodiments 1-5, wherein the length (18f) of the damage region (18b) induced in the transparent workpiece along the laser beam propagation direction is shorter than the thickness of the plate-like workpiece (7) and is not adjoined to any of the surfaces of the plate-like workpiece, or the length (18f) of the damage region coincides with the thickness of the workpiece and is adjoined to both of the surfaces (7a, 7b) of the plate-like workpiece, or the length (18f) of the damage region is shorter than the thickness of the plate-like workpiece (7) and is adjoined to only one of the surfaces (7a, 7b).
7. Device for processing transparent materials making up a workpiece (7), comprising
a laser source (1) for generating a laser beam,
an optical system, for forming a Gauss-Bessel intensity profile laser beam from the laser beam and localizing the Gauss-Bessel intensity profile laser beam in the workpiece (7), to form in the workpiece (7) a damage region along the beam propagation direction,
a positioning mechanism controlled by a controller, for displacement of the transparent workpiece (7) and Gauss-Bessel intensity profile laser beam in respect to each other, so that a required number of additional adjacent damage regions are created in a predefined trajectory in order to form a cutting and/or breaking plane of the workpiece,
characterized by:
an optical element (3, 3′, 3″) placed in the path of the beam to disrupt the symmetry of the Gauss-Bessel intensity profile laser beam to form an asymmetric Gauss-Bessel intensity profile laser beam (6b) localized in the workpiece (7) inducing a damage region (18b), which has an elongated shape in the plane perpendicular to the laser beam propagation direction and,
wherein the positioning mechanism controlled by the controller (10) is arranged to perform a controlled displacement of the transparent workpiece (7) and Gauss-Bessel intensity profile laser beam (6b) relative to each other in such a manner, that the elongated shape damage regions (18b) are induced longitudinally one after other along the predefined trajectory of the cutting and/or breaking plane in the workpiece.
8. Device according to embodiment 7, wherein the laser source is arranged to generate an ultrashort pulse Gaussian intensity profile laser beam and direct it to the optical system, a laser pulse duration and a laser pulse energy of the directed laser beam (2) being selected to exceed a material damage threshold of the workpiece (7) to form in it the damage region, which extends in the direction of propagation of the laser beam.
9. Device according to embodiment 7 or 8 wherein the optical element (3) is a transparent material plate arranged to create asymmetry of the laser beam to form the asymmetric Gauss-Bessel intensity profile laser beam (6b) by introducing an additional optical path for part of the laser beam with respect to the other part of the laser beam.
10. Device according to embodiment 7, 8 or 9 wherein the optical element (3) is a transparent plate (14a, 14b, 14c) placed in the optical path of the laser beam for partial coverage of the laser beam, for splitting the beam into asymmetric parts.
11. Device according to embodiment 7 or 8 wherein the optical element (3, 3′, 3″) is a transparent plate (14a) in the optical path of the Gaussian or Gauss-Bessel intensity profile laser beam covering part of the laser beam, where the covered and uncovered parts of the laser beam are symmetrical, so that the uncovered part of the beam passes directly past the transparent plate (3,3′, 3″) whereas the covered part of the beam passes through the transparent plate (3, 3′, 3″).
12. Device according to embodiment 7 or 8, wherein the optical element (3, 3′, 3″) is a transparent plate (14b) having a first zone and a second zone of different thickness, which is placed in the optical path of the Gaussian or Gauss-Bessel intensity profile laser beam in such a manner, that the laser beam is split in to two parts, where the first part of the beam passes through the first zone of the plate (14b) and the second part of the beam passes through the second zone of the plate (14b).
13. Device according to embodiment 7 or 8 wherein the optical element (3, 3′, 3″) is a transparent plate (14c) having a first zone and a second zone of different refractive index, which is placed in the optical path of the Gaussian or Gauss-Bessel intensity profile laser beam in such a manner, that the aforementioned laser beam is split in to two parts, where the first part of the beam passes through the first zone of the plate (14c) and the second part of the beam passes through the second zone of the plate (14c).
14. Device according to embodiment 9, 11, 12 or 13, wherein the two parts are equal symmetrical parts.
15. Device according to any of the embodiments 7 to 14 wherein the positioning mechanism controlled by the controller (10) comprises a rotary stage (15, 15′, 15″), to which the optical element (3, 3′, 3″) is attached, and a linear motion stage (8), to which the workpiece (7) is attached, wherein the stages (15, 15′, 15″) and (8) are controlled by the controller (10), which receives commands from a computer (9) according to predefined trajectory of the cutting and/or breaking plane in such a manner, that the direction of trajectory of the cut and/or break plane is controlled by the stage (15, 15′, 15″), rotating the optical element (3, 3′, 3″), and the positioning of the damage regions (18b) in the workpiece (7) at a certain displacement distance (18e) is controlled by stage (8) linearly moving the workpiece (7).
16. Device according to any of the embodiments 7 to 15 wherein the positioning mechanism controlled by the controller (10) comprises:
a Dove prism (16, 16′), placed in the optical path of the Gaussian or Gauss-Bessel intensity profile laser beam behind the stationary optical element (3) according to the direction of the laser beam propagation and attached to the rotary stage (15, 15′), and the linear motion stage (8), to which the workpiece (7) is attached, wherein stages (15, 15″) and (8) are controlled by the controller (10), which receives commands from computer (9) according to predefined trajectory of the cutting and/or breaking plane in such a manner, that the direction of trajectory of the cut and/or break plane is controlled by stage (15, 15″) rotating Dove prism (16, 16′), and the positioning of the damage regions (18b) in the workpiece (7) at a certain displacement distance (18e) is controlled by stage (8) linearly moving the workpiece (7).
17. Device according to embodiment 16 further comprising a quarter wave phase plate (16b, 16b′) for changing polarization state of the laser radiation of the laser source (1) from linear to circular, which is placed in the laser beam path in front of or behind the optical element (3) and in front of the Dove prism (16, 16′) according to the direction of the laser beam propagation.
18. Device according to embodiment 16, further comprising a half wave phase plate (16b″) for maintaining the same polarization state of the laser radiation of the laser source (1) which is placed in the laser beam path behind the optical element (3) and in front of the Dove prism (16) according to the direction of the laser beam propagation and attached to the rotary stage (15) for rotating phase plate (16b″) together with the Dove prism (16).
19. Method for processing transparent materials comprising the steps of:
directing ultrashort pulse Gaussian intensity profile laser beam (2) from the laser source (1) to an optical system, generating Gauss-Bessel intensity profile laser beam,
localizing generated Gauss-Bessel intensity profile laser beam in a workpiece (7), wherein the material of the workpiece is transparent to the localized Gauss-Bessel intensity profile laser beam and, wherein a laser pulse duration and a laser pulse energy of the directed laser beam (2) are selected to exceed material damage threshold of the workpiece (7) and to form in the workpiece a damage region, which extends in the direction of propagation of the laser beam,
performing controlled displacement of the workpiece (7) and the laser beam with respect to each other to create a required number of additional adjacent damage regions in a predefined trajectory in order to form a cutting and/or breaking plane of the workpiece (7),
characterized by
transforming the ultrashort pulse Gaussian intensity profile laser beam (2) to asymmetric Gauss-Bessel intensity profile laser beam (6b) by placing an optical element (3, 3′, 3″) in the optical path of the Gaussian or Gauss-Bessel intensity profile laser beam, wherein asymmetry of the asymmetric Gauss-Bessel intensity profile laser beam is set by selecting appropriate material of the optical element (3, 3′, 3″) and/or parameters of the optical element (3, 3′, 3″) and/or position of the optical element (3, 3′, 3″) in the optical laser beam path in order to form elongated shape of the Gauss-Bessel intensity profile laser beam in the plane, perpendicular to the direction of propagation of the laser beam, inducing correspondingly an elongated damage region (18b) in the workpiece (7), and wherein the controlled displacement of the workpiece (7) and the laser beam relative to each other is performed in such a manner that the induced elongated shape damage regions (18b) are arranged in the workpiece (7) longitudinally one after the other along the predefined trajectory of the cutting and/or breaking plane.
20. Method according to embodiment 19, characterized in that the elongated shape of the induced damage region (18b) in the plane perpendicular to the laser beam propagation direction is similar to the shape of an ellipse.
21. Method according to embodiment 19 or embodiment 20, characterized in that the elongated shape damage regions (18b) are positioned at a certain distance one from another within the workpiece (7) along the trajectory of the cutting and/or breaking plane, so that the distance dx between the centers of the adjacent damage regions is in the range from about 0.5 to about 15 lengths of a single damage region (18e), where the length of a damage region (18b) along the longer axis (18e) is from about 1 μm to about 20 μm, and the length of the damage region along the longer axis is from 1.3 to 5 times, preferably 2 times, larger than the length along the shorter axis.
22. Method according to any of the embodiments 19-21, characterized in that the transparent material of the workpiece (7) is selected from the group consisting of glass, chemically strengthened glass, sapphire or other crystalline material.
23. Method according to any of the embodiments 19-22, characterized in that the length (18f) of the damage region (18b) induced in the transparent workpiece along the laser beam propagation direction is shorter than the thickness of the plate-like workpiece (7) and is not adjoined to any of the surfaces of the plate-like workpiece, or the length (18f) of the damage region coincides with the thickness of the workpiece and is adjoined to both of the surfaces (7a, 7b) of the plate-like workpiece, or the length (18f) of the damage region is shorter than the thickness of the plate-like workpiece (7) and is adjoined to only one of the surfaces (7a, 7b).
24. Device for processing transparent materials, comprising
a laser source (1), generating ultrashort pulse Gaussian intensity profile laser beam (2),
an optical system, forming Gauss-Bessel intensity profile laser beam and localizing the beam in a workpiece (7), wherein the material of the workpiece is transparent to Gauss-Bessel intensity profile laser beam, which has laser pulse duration and energy selected to exceed optical damage threshold of the workpiece (7) material and to form in the workpiece it a damage region along the beam propagation direction,
a positioning mechanism controlled by a controller, for displacement of the transparent workpiece (7) and Gauss-Bessel intensity profile laser beam in respect to each other, so that a required number of additional adjacent damage regions are created in a predefined trajectory in order to form a cutting and/or breaking plane of the workpiece, characterized by
an optical element (3, 3′, 3″) placed in the path of the Gaussian or Gauss-Bessel intensity profile beam to disrupt the symmetry of the Gauss-Bessel intensity profile laser beam, wherein the optical system forms asymmetric Gauss-Bessel intensity profile laser beam (6b) and localizes the beam in the workpiece (7) inducing damage region (18b), which has elongated shape in the plane perpendicular to the laser beam propagation direction and,
wherein the positioning mechanism controlled by the controller (10) is designed to perform controlled displacement of the transparent workpiece (7) and Gauss-Bessel intensity profile laser beam (6b) relative to each other in such a manner, that the elongated shape damage regions (18b) are induced longitudinally one after other along the predefined trajectory of the cutting and/or breaking plane in the workpiece.
25. Device according to embodiment 24, characterized in that the optical element (3, 3′, 3″) is a transparent plate (14a), that is placed in the optical path of the Gaussian or Gauss-Bessel intensity profile laser beam in such a manner, that the optical element covers half of the laser beam, where the covered and uncovered parts of the laser beam are symmetrical, and the uncovered part of the beam passes directly, whereas the covered part of thebeam passes through the transparent plate (3, 3′, 3″).
26. Device according to embodiment 24, characterized in that the optical element (3, 3′, 3″) is a transparent plate (14b) having a first zone and a second zone of different thickness, which is placed in the optical path of the Gaussian or Gauss-Bessel intensity profile laser beam in such a manner, that the laser beam is split in to two equal symmetrical parts, where the first part of the beam passes through the first zone of the plate (14b) and the second part of the beam passes through the second zone of the plate (14b).
27. Device according to embodiment 25, characterized in that the optical element (3, 3′, 3″) is a transparent plate (14c) having a first zone and a second zone of different refractive index, which is placed in the optical path of the Gaussian or Gauss-Bessel intensity profile laser beam in such a manner, that the aforementioned laser beam is split in to two equal symmetrical parts, where the first part of the beam passes through the first zone of the plate (14c) and the second part of the beam passes through the second zone of the plate (14c).
28. Device according to any of the embodiments 24-27, characterized in that the positioning mechanism controlled by the controller (10) comprises a rotary stage (15, 15′, 15″), to which the optical element (3, 3′, 3″) is attached, and a linear motion stage (8), to which the workpiece (7) is attached, wherein the stages (15, 15′, 15″) and (8) are controlled by the controller (10), which receives commands from computer (9) according to predefined trajectory of the cutting and/or breaking plane in such a manner, that the direction of trajectory of the cut and/or break plane is controlled by the stage (15, 15′, 15″), rotating the optical element (3, 3′, 3″), and the positioning of the damage regions (18b) in the workpiece (7) at a certain displacement distance (18e) is controlled by stage (8) linearly moving the workpiece (7).
29. Device according to any of the embodiments 24-27, characterized in that the positioning mechanism controlled by the controller (10) comprises:
a Dove prism (16, 16′), placed in the optical path of the Gaussian or Gauss-Bessel intensity profile laser beam behind the stationary optical element (3) according to the direction of the laser beam propagation and attached to the rotary stage (15, 15′), and
the linear motion stage (8), to which the workpiece (7) is attached, wherein stages (15, 15″) and (8) are controlled by the controller (10), which receives commands from computer (9) according to predefined trajectory of the cutting and/or breaking plane in such a manner, that the direction of trajectory of the cut and/or break plane is controlled by stage (15, 15″) rotating Dove prism (16, 16′), and the positioning of the damage regions (18b) in the workpiece (7) at a certain displacement distance (18e) is controlled by stage (8) linearly moving the workpiece (7).
30. Device according to embodiment 29, characterized by a quarter wave phase plate (16b, 16b′) for changing polarization state of the laser radiation of the laser source (1) from linear to circular, which is placed in the laser beam path in front of or behind the optical element (3) and in front of the Dove prism (16, 16′) according to the direction of the laser beam propagation.
31. Device according to embodiment 29, characterized by a half wave phase plate (16b″) for maintaining the same polarization state of the laser radiation of the laser source (1) which is placed in the laser beam path behind the optical element (3) and in front of the Dove prism (16) according to the direction of the laser beam propagation and attached to the rotary stage (15) for rotating phase plate (16b″) together with the Dove prism (16).

Embodiments of the present disclosure relate to the field of lasers, particularly to laser processing of transparent materials and can be used for cutting, breaking and other kind of processing of transparent materials, such as glass, chemically strengthened glass, sapphire and other crystalline materials, employing ultrashort pulse asymmetric Gauss-Bessel intensity profile laser beam. Gaussian intensity profile ultrashort pulse laser beam may be transformed to asymmetric Gauss-Bessel intensity profile laser beam by inserting an optical element in Gaussian or Gauss-Bessel intensity profile laser beam path. Asymmetry of Gauss-Bessel intensity profile laser beam may be set by selecting appropriate material of the optical element and/or parameters of the optical element and/or position of the optical element in the optical beam path in such a manner, that Gauss-Bessel intensity profile laser beam, localized in the workpiece, has an elongated shape in the propagation direction of the laser beam and in the plane, perpendicular to the direction of propagation of said laser beam and induces correspondingly elongated shape damage region in the workpiece.

Controlled displacement of the workpiece and the laser beam in respect to each other may be performed to create a required number of additional elongated shape damage regions and to arrange them in the workpiece longitudinally one after other along the predefined trajectory forming the cutting and/or breaking plane of the workpiece.

1. A workpiece part comprising:
parts of elongated damage regions which are arranged longitudinally one after another along a predefined trajectory and form a cutting and/or breaking plane along which a workpiece was divided to form the workpiece part;
wherein the material of the workpiece part is transparent;
wherein each elongated damage region part in the workpiece material extends over a length in a first direction and has a shape that is elongated in a plane perpendicular to the first direction.

2. The workpiece part according to claim 1, wherein each damage region was formed by an ultrashort pulse laser beam having an asymmetric Gauss-Bessel intensity profile which has an elongated shape in the plane perpendicular to a laser beam propagation direction and the first direction corresponds to the direction of propagation of the laser beam.

3. The workpiece part according to claim 1, wherein the elongated shape of the damage region parts in the plane perpendicular to the first direction is in the shape of a segment of an ellipse.

4. The workpiece part according to claim 1, wherein the parts of the elongated shape damage regions are positioned at a distance dx one from another along the trajectory of the cutting and/or breaking plane, wherein the distance dx between the centers of the adjacent damage region parts is in the range from 0.5 to 15 lengths of a single damage region part, where the length of a damage region along the longer axis is from 1 μm to 20 μm, and the length of the damage region along the longer axis is from 1.3 to 5 times, preferably 2 times, larger than the length along the shorter axis.

5. The workpiece part according to claim 1, wherein the transparent material of the workpiece is selected from the group consisting of glass, chemically strengthened glass, sapphire or other crystalline material.

6. The workpiece part according to claim 1, wherein the workpiece part is plate-like and wherein the length of the damage region part induced in the transparent workpiece along the first direction is shorter than the thickness of the plate-like workpiece part and is not adjoined to any of the surfaces of the plate-like workpiece, or the length of the damage region coincides with the thickness of the workpiece and is adjoined to both of the surfaces of the plate-like workpiece, or the length of the damage region is shorter than the thickness of the plate-like workpiece and is adjoined to only one of the surfaces.
